(19) United States
(12) Patent Application Publication
(10) Pub. No.: US 2012/0054737 A1
(43) Pub. Date: Mar. 1, 2012

(54) SYSTEM AND METHOD FOR A ONE-CLICK INSTALL OF AN OBJECT MODEL INTO A MULTI-MEDIA INTERACTIVE ENVIRONMENT

(76) Inventor: Jonathan HASWELL, San Francisco, CA (US)

(21) Appl. No.: 13/222,934

(22) Filed: Aug. 31, 2011

Related U.S. Application Data
(60) Provisional application No. 61/378,761, filed on Aug. 31, 2010.

(51) Int. Cl. G06F 9/44; G06F 15/16

(52) U.S. Cl. 717/173

(57) ABSTRACT

One-click installation of computer models in a virtual environment. Downloading, extracting, analyzing, installing, and configuration of computer models of objects for use in a multimedia interactive simulation environment on a target user machine platform on which a game will run. Automatically installing Mods when user joins a game and performing quality checks to ensure that the game will function properly given the Mod being installed.

### CROSS REFERENCE TO RELATED APPLICATIONS

This application claims priority to United States Provisional Patent Application Ser. No. 61/378,761, filed Aug. 31, 2010, entitled “A System and Method For a One-Click Install of an Object Model into a Multi-Media Interactive Environment” which is incorporated herein in its entirety.

### BACKGROUND OF THE INVENTION

1. Technical Field

The invention relates generally to interactive electronic games and automatically installing object models in multimedia interactive environments. More specifically, the invention relates to interactive electronic games that use three dimensional modeling and automatically downloading and configuring object models that describe virtual objects in an interactive environment such as a video game.

2. Description of the Prior Art

Three Dimensional (“3D”) models for virtual objects are complex. In particular, models for realistic vehicles and racetracks for interactive simulation environments are extremely complicated in both substance and in organizational structure.

Online gaming enjoys widespread popularity with many users who, not only play the games, but who also construct models and develop modifications to in-game objects. For example, some on-line racing games have a user base that is very active in constructing models, or “Mods”, and model revisions for cars and tracks.

Mod building involves obtaining the game files, and possibly a set of developer tools, and altering objects or creating entirely new content to import into the game. When a Mod is created, the builder or team of builders may not necessarily apply sufficient diligence to the organization of the files and directories involved. As a result, the Mod may be difficult to install in the game database for a user who wishes to utilize the model in a game.

Additionally, a Mod typically consists of a collection of files and directory structures which have been compressed into a file such as a ZIP file. The ZIP file format is a data compression and archive format. A ZIP file contains one or more files that have been compressed to reduce file size, or stored as-is.

The compression of Mod files makes the process of installing a Mod even more complex. For example, a user oftentimes must unzip or decompress a ZIP file and individually move files and directories into the appropriate locations on the user machine where the game is to operate. Not only is this process tedious, but it is also error-prone.

It would be advantageous to provide a solution that overcomes the deficiencies of the prior art, and enables easy and accurate installation of Mods into such simulation environments.

### SUMMARY OF THE INVENTION

The invention provides a user-friendly, one-click system of downloading and properly installing object models in a gaming environment. In some embodiments of the invention, the system is configured for automatically downloading, extracting, installing, and configuring an object model upon a single user action.

In some embodiments of the invention, a Mod service module is configured for performing some or all of the necessary processing functions for ensuring the that Mods are properly configured on a user's gaming machine.

Some embodiments of the invention involve a process for one-click (aka single-click) Mod installation by a user's internal game client. According to these embodiments, the process determines that a payment is required to join a game server before scanning a user's system for installed Mods. Subsequent scanning includes referencing an XML file to determine if one or more Mods are properly downloaded, extracted, installed, and configured on a user system. Upon discovery of a user system requiring one or more properly configured Mods, the process involves automatically downloading, extracting, installing, and configuring an object model upon a single user action.

Some other embodiments of the invention involve a process for one-click Mod installation by an external game client.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 illustrates an overview of a system for operating an on-line game and for allowing one-click mod installation;

FIG. 2A illustrates an example file and directory structure for a vehicle as it is located in a ZIP file for a Mod;

FIG. 2B illustrates an example file and directory structures for a track it is located in a ZIP file for a Mod;

FIG. 3A illustrates a system for automatically configuring and installing one or more Mod using a Mod service module according to some embodiments of the invention;

FIG. 3B illustrates a data flow diagram demonstrating a re-mapping of the contents of a compressed or ZIP Mod file containing the information necessary to implement a Mod on during a one-click install operation according to some embodiments of the invention;

FIG. 4 illustrates an exemplary process of downloading and configuring a Mod to be used in a racing simulation game according to some embodiments of the invention;

FIG. 5 illustrates the process showing how a user joins a game server with automatic Mod installation on the host game website prior to joining a game; and

FIG. 6 is a block schematic diagram of a machine in the exemplary form of a computer system within which a set of instructions may be programmed to cause the machine to execute the logic steps of the invention.

### DETAILED DESCRIPTION OF THE INVENTION

The invention involves systems and methods for providing users of on-line video gaming platforms with a simple one-click install feature to install computer models (hereinafter “Mods”) in a virtual environment. In the presently preferred embodiments of the invention 3D computer models of objects, such as vehicles and race tracks for use in a multimedia interactive simulation environment, are downloaded and installed on a target user machine platform on which a game runs. Preferably, this is done in response to the single user input, such as a mouse click.

By using a Mod service module, all the files needed for the successful installation of the Mods are quickly and easily downloaded, configured, and installed correctly and automatically without advance knowledge of Mod development or the necessary organizational structured required by the game server.

The invention also involves installation of 3D models along with quality checks that ensure that the game will function properly when a user joins a game in which the model is expected to be installed.

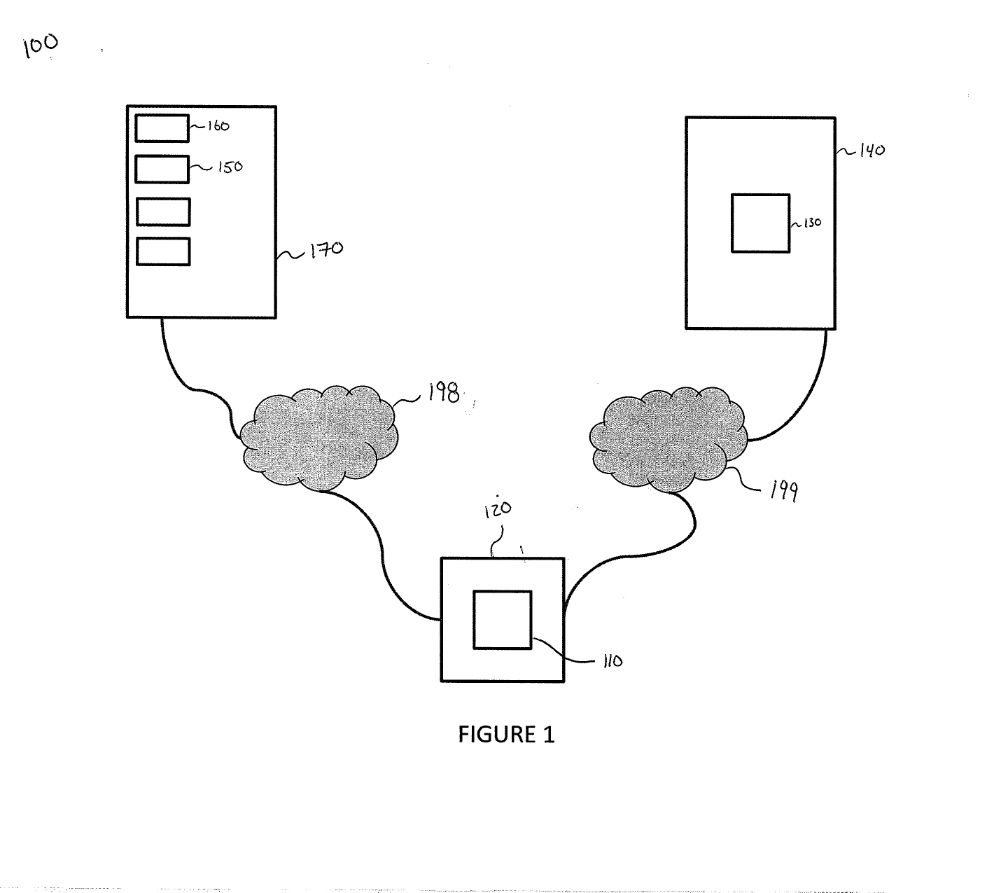

FIG. 1 illustrates an overview of a system 100 for operating an on-line game and for allowing one-click mod installation. According to FIG. 1, a game client 110 resides on a user machine 120 and communicates with a game server 130 located on a host game website 140 via a network 199, such as the Internet. In the presently preferred embodiments of the invention, a plurality of user machines are coupled with the game server 130. In some embodiments of the invention, the user machine 120 is selected from a PC, a game console, a smartphone; however, it will be readily apparent to those with ordinary skill in the art having the benefit of this disclosure that any embodiment of the automatic Mod installation method can be employed with any computer platform capable of running the video game, now known or later developed.

Mod files are made available to user machines 120 from a content delivery network (“CDN”) 170 or from the game website 140. As shown in FIG. 1, an on-line CDN 170 makes a plurality of mods available for download via a network 198, such as the Internet.

In some embodiments of the invention, the network 199 or the network 198 comprises one or more of any type of computer network including a local area network (LAN), personal area network (PAN), wide area network (WAN), metropolitan area network (MAN), wireless local area network (WLAN), wireless wide area network (WWAN), peer-to-peer network, or other computer network, now know or later developed. Additionally, the network 199 and the network 198 may be either the same network or different networks.

Typically Mod developers store Mods in a directory structure that contains all the necessary files, and frequently in an appropriately compressed form. For example, in the case of an online 3D car racing game, the CDN 170 may contain new models of one or more vehicle 150, new models of one or more race track 160, among other object types.

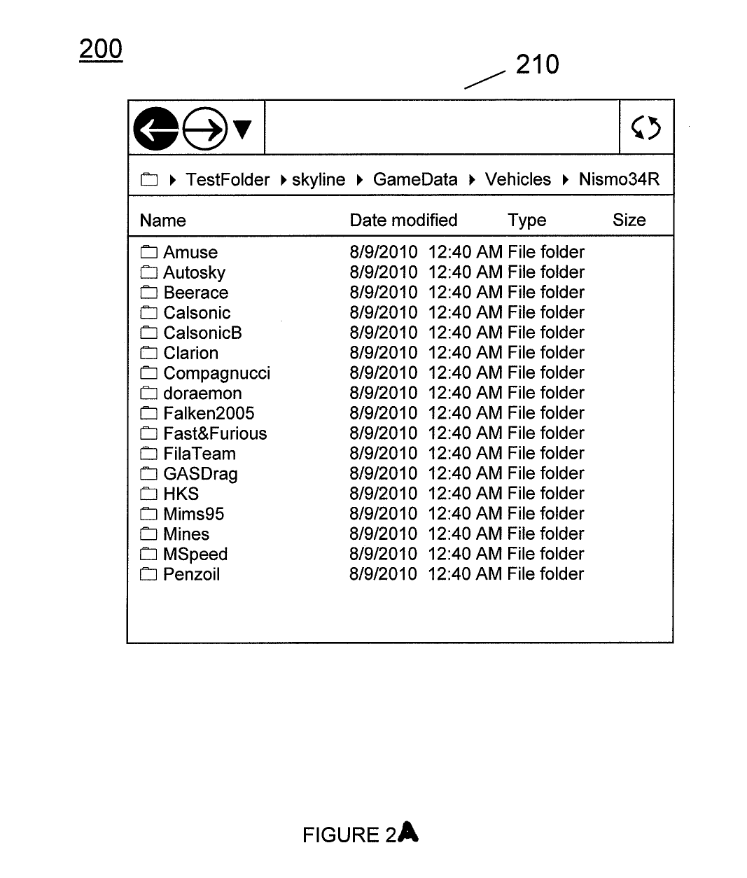

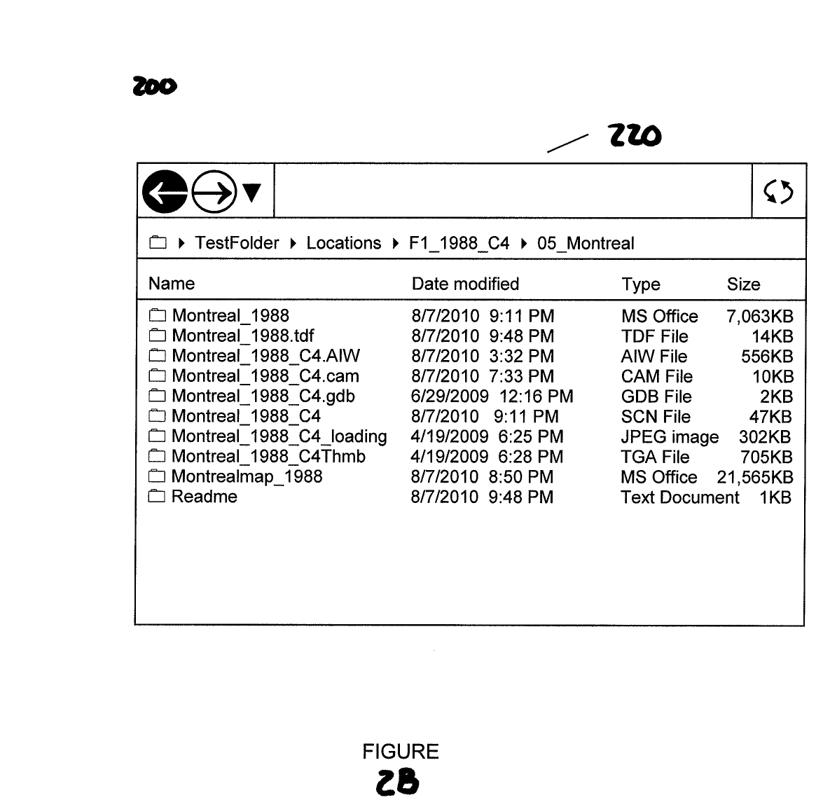

As explained above, Mods are oftentimes comprised of very complicated collections of object files, executable files, directory structures, etc. FIGS. 2A and 2B illustrate example file and directory structures 200 for a vehicle 210 and a track 220 as they are located in a ZIP file for a Mod. Oftentimes the ZIP files for various Mods have different file structures, thereby complicating the installation process. Furthermore, there are files that have certain minimum requirements for the system to properly function while others are additions and may or may not exist for a specific Mod.

Due to the complexities in Mod creation, organization, installation, and maintenance, the inventors developed a Mod service module which automatically examines a Mod and automatically downloads and installs the various file and directories in the appropriate locations on the game client. As used herein, the term “module” refers to any software, firmware, and/or hardware processing component or portion thereof that may be used to implement one or more of the processing functions of the invention.

In the presently preferred embodiments of the invention, the Mod service module analyzes the received/downloaded Mod files and directories to ensure that the Mod is complete and that the subcomponents are appropriate and correct. Next, the Mod service module automatically installs files and directories into the proper directory locations that the game client program will utilize when it operates on a user's gaming machine.

In some embodiments of the invention, the Mod service module is available to users locally on their gaming machine. In some other embodiments of the invention, the Mod service module is available from the game server or the CDN via a network.

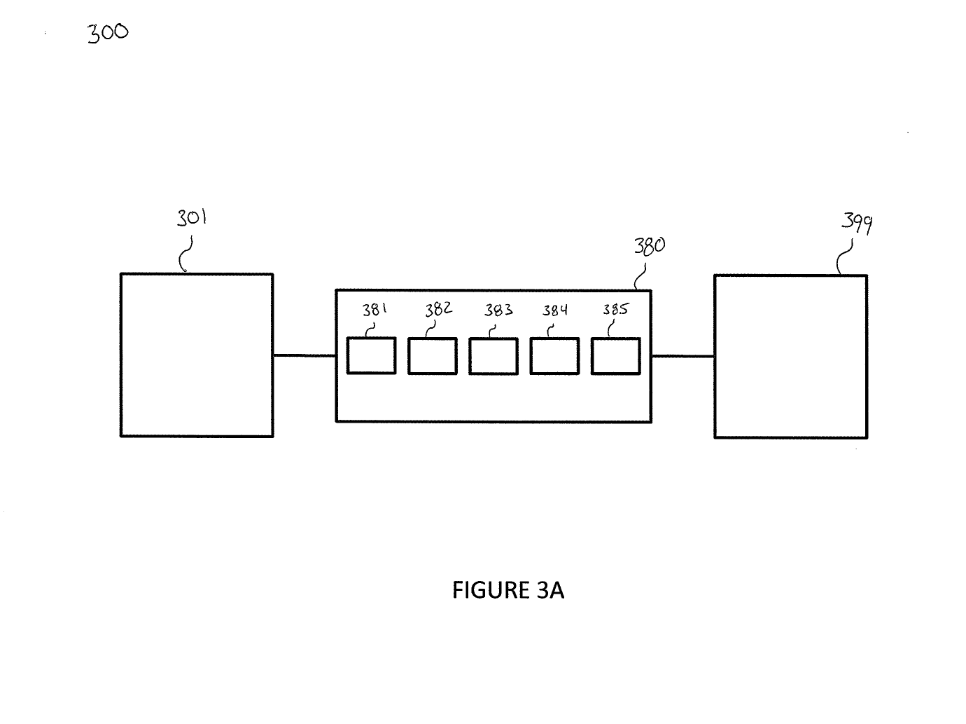

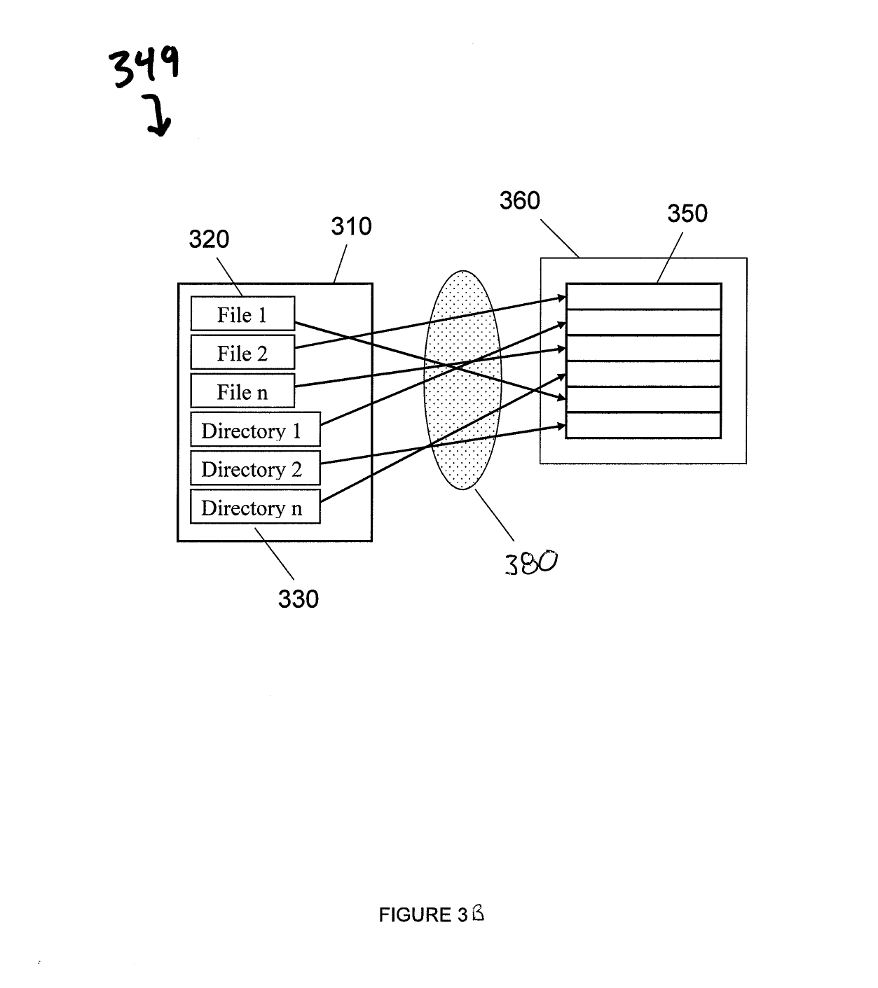

FIG. 3A illustrates a system 300 for automatically configuring and installing one or more Mod using a Mod service module 380 according to some embodiments of the invention. The system 300 includes the Mod service module 380 operatively coupled with a Mod provider 301 and a user device 399. In some embodiments of the invention, the Mod service module 380 includes one or more sub-modules including a Mod gatherer 381, a Mod analyzer 382, a directory analyzer 383, a re-mapper 384, and an updater 385.

FIG. 3B illustrates a data flow diagram 349 demonstrating a re-mapping of the contents of a compressed or ZIP Mod file 310 containing the information necessary to implement a Mod during a one-click install operation according to some embodiments of the invention. As shown in FIG. 3B, the ZIP file 310 contains individual design files 320 as well as directories 330 containing groups of files. The design files 320 and the directories 330 are operated upon by the Mod service module 380 to examine them for completeness and correctness and each is copied into an appropriate directory 350 on the user machine 360. In some embodiments of the invention, if the Mods are not properly organized, the Mod service module 380 re-maps the data structure for compliance with the game server.

The Mod service module 380 is available to the user as part of the user's in-game client, as part of the game developers' external game client, as an offering from a CDN, or as a standalone peripheral device. In the presently preferred embodiments of the invention, the internal game client performs the same functions as the external game client, with the exception of launching independent of the game.

In some embodiments of the invention, access to the Mod service module 380 is available to users through a one-time payment. In some other embodiments, access to the Mod service module 380 is available on a subscription-based membership. In yet other embodiments of the invention, the Mod service module 380 is available free.

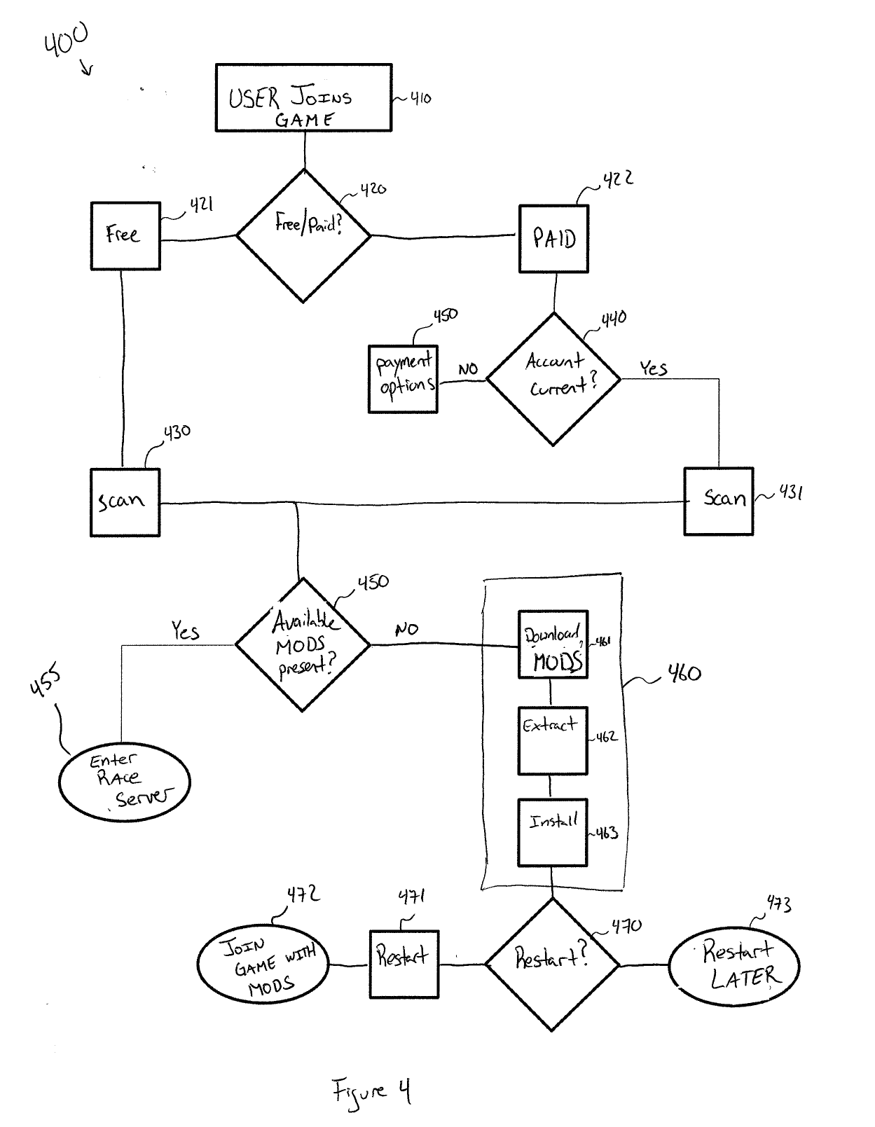

FIG. 4 illustrates an exemplary process 400 of downloading and configuring a Mod during a racing simulation game according to some embodiments of the invention. According to FIG. 4, the process 400 is executed by the in-game client (Internal Game Client) and executed on a user's machine when a user joins a game.

The process 400 begins with a user joining 410 a game. In some embodiments, a game is previously scheduled and a user logs onto the server before the start time. In some embodiments, a user initiates a new game. In some other embodiments, a user enters a practice/simulation game. In yet other embodiments, the user initiates a “ready check” to test the preparedness of the game client, game server, or both in anticipation of the user actually joining a game. While these specific examples of game-joining are discussed explicitly herein, it will be apparent to those having ordinary skill in the art and having the benefit of this disclosure that a wide variety of network game joining types will benefit from this invention.

Subsequently, the client determines 420 if the game is free or paid. If the game is a paid game 422, then the client determines if the user has paid 440 the appropriate entry fee. If they have not paid the entry fee, then the user is rejected 450 and told how to pay. If the user has already paid 460, then the client performs scan 431 to determine if all Mods are present.

If it is determined that the game is free 421, the client performs a scan 430 to determine if all of the Mods required to join that particular game are present. In some embodiments of the invention, the Mods that the user is required to have downloaded and installed are dependent on the game that the user chooses. For example, the user may choose to join a racing game on a newly-modeled race track in a newly-modeled race car. The scan 430 is performed to determine if the user has both track and car Mods.

In the presently preferred embodiments of the invention, the step of scanning involves referencing an XML file associated with a Mod. For example, before a user proceeds with either joining a game server or downloading one or more Mods, the game client (either internal or external) makes a software call to the source of the Mod and references a Mod ID variable. According to these embodiments, the game client uses the Mod ID to reference an XML file that is associated with the mod. The XML file contains the file structure of the Mods. The client downloads and scans the XML file to see if user's machine already has an identical file and folder structure in place. If the user does have the same files and folders that were in the XML file, the mod is bypassed. If the user does not have the same files and folders, is missing some files, or the files are in an incorrect directory, the Mod will be downloaded by the client.

According to either step 430 or step 431, the in-game client performs a scan in order to determine 450 if all of the required Mods are present on the user's machine. If the client determines that the proper Mods are present, then the user joins the race server 455. If the in-game client determines that the proper Mods are not present, then the in-game client initiates the process of automatic Mod configuration 460.

Automatic Mod configuration comprises downloading the mod(s) 461, or missing portions thereof, extracting the Mod's content 462, and installing 463 the Mod's files and directories as required on the user machine. When the extraction and installation process is complete, the user is prompted 470 with a message such as “restart <in-game client name> to use your new mod?” The user may then choose to restart the in-game client now 471 and subsequently rejoin the server with the Mods installed 472 or restart later 473.

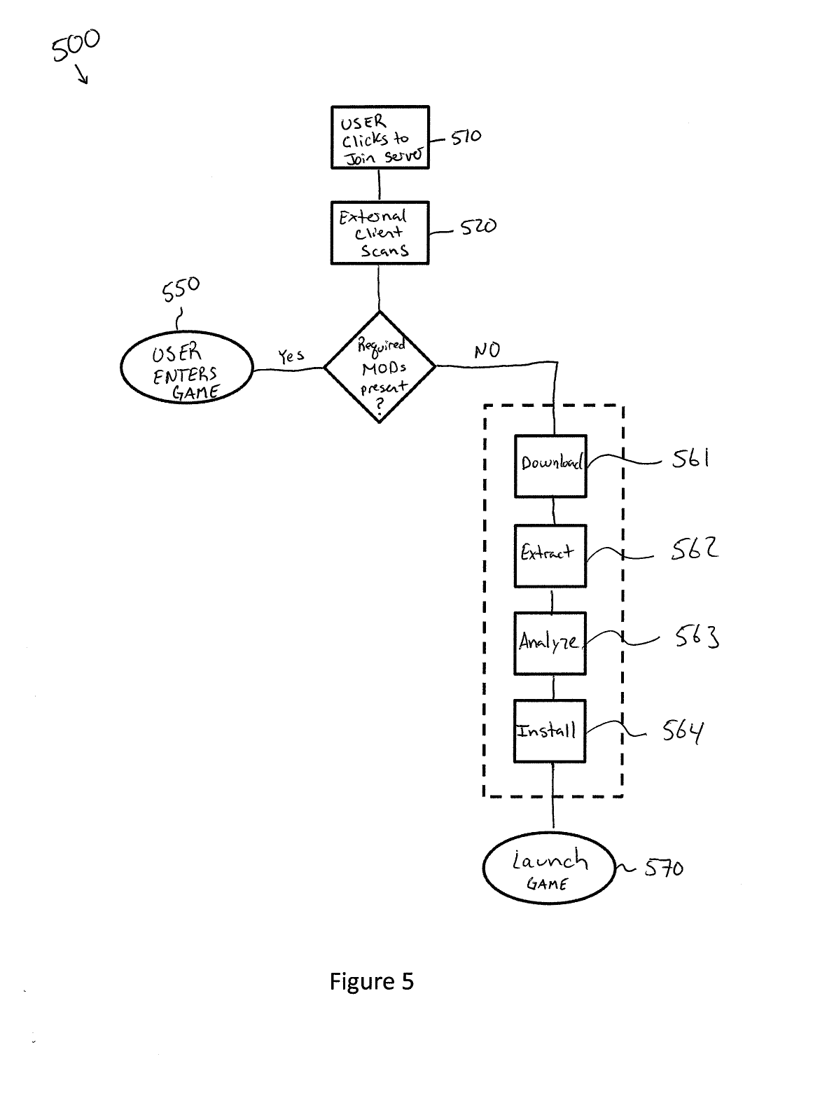

As explained above, the process of automatic Mod downloading, installation, and configuration is accomplished by a game client internal to user's computer or by the external client on the game server. FIG. 5 illustrates the process 500 showing how a user joins a game server with automatic Mod installation using an external client coupled with the host game website prior to joining a game. The process 500 is initiated when a user clicks 510 to join a server on the website and the external game client scans 520 the user's computer to determine 530 if the required Mods are present.

If the Mods are present and appropriately installed the user may join 550 the race server. If the required Mods are not present on the user's machine, then the internal game client downloads the required Mod 561, extracts it 562, analyzes it for completeness and correctness 563, and installs it 564 in the appropriate file and directory locations. When the extraction and installation process is complete, the game is launched 570.

As explained above, the invention is applicable to other forms of games that involve object modification. More generally it applies to the modification of any virtual objects moving through a 2D or 3D dimension. For example, the modified object may be a flying object such as a plane flying over a specific terrain, a building, a particular piece of clothing or other accoutrement for a virtual character, or any other type of virtual object. Hence, the description herein with respect to motor vehicle race tracks should not be viewed as limiting upon the principles taught in this invention. The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

At least certain principles of the invention can be implemented as hardware, firmware, software or any combination thereof. Moreover, the software is preferably implemented as an application program tangibly embodied on a program storage unit, a non-transitory user machine readable medium, or a non-transitory machine-readable storage medium that can be in a form of a digital circuit, an analogy circuit, a magnetic medium, or combination thereof. The application program may be uploaded to, and executed by, a machine comprising any suitable architecture. Preferably, the machine is implemented on a user machine platform having hardware such as one or more central processing units (“CPUs”), a memory, and input/output interfaces. The user machine platform may also include an operating system and microinstruction code. The various processes and functions described herein may be either part of the microinstruction code or part of the application program, or any combination thereof, which may be executed by a CPU, whether or not such user machine or processor is explicitly shown. In addition, various other peripheral units may be connected to the user machine platform such as an additional data storage unit and a printing unit.

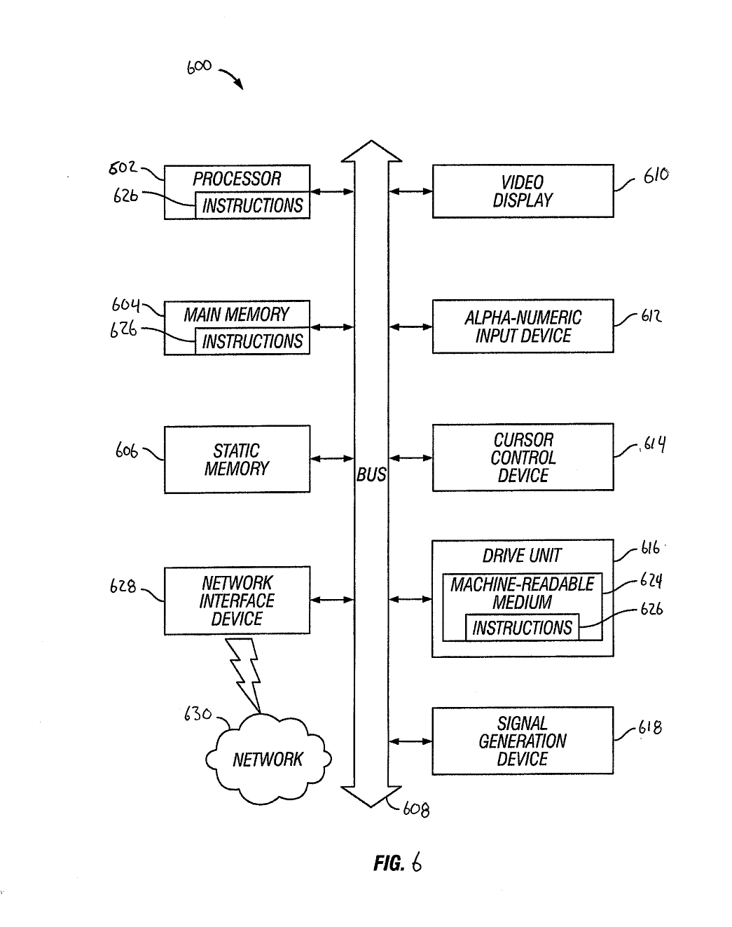

FIG. 6 is a block schematic diagram of a machine in the exemplary form of a computer system 600 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a display unit 610, for example, a liquid crystal display (LCD) or a cathode ray tube (CRT). The computer system 600 also includes an alphanumeric input device 612, for example, a keyboard; a cursor control device 614, for example, a mouse; a disk drive unit 616, a signal generation device 618, for example, a speaker, and a network interface device 620.

The disk drive unit 616 includes a machine-readable medium 624 on which is stored a set of executable instructions, i.e. software, 626 embodying any one, or all, of the methodologies described herein below. The software 626 is also shown to reside, completely or at least partially, within the main memory 604 and/or within the processor 602. The software 626 may further be transmitted or received over a network 628, 630 by means of a network interface device 620.

In contrast to the system 600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention described herein with reference to the preferred embodiments, one skilled in the art will readily appreciate that other applications may be substituted for those set forth herein without departing from the spirit and scope of the invention. Accordingly, the invention should only be limited by the Claims included below.

1. A system comprising:
a game client operating on a user computer;
a game server operating on a host website;
a content delivery network (“CDN”) containing at least one object model (“MOD”), in a compressed form, available for download and installation on said user computer to be used in conjunction with said game client; and
a Mod service module operatively coupled with said game client and said game server, said Mod service module containing a processing element configured to receive a signal from said user computer that represents a single input, wherein said Mod service module is configured to automatically download, in response to the receipt of said signal, said at least one Mod, extract said at least one Mod, analyze said at least one Mod, and automatically install said at least one Mod in the appropriate locations on said user computer.

2. The system of claim 1, wherein said Mod service module is available to said user computer via said host website.

3. The system of claim 1, wherein said Mod service module is local to said user computer.

4. The system of claim 1, wherein said Mod service module is further configured for scanning said user computer to determine the presence of pre-existing Mods.

5. The system of claim 1, wherein said Mod contains a plurality of files organized in one or more file directories, wherein said plurality of files comprises at least one XML filed describing said at least one Mod, and wherein said Mod service module is further configured for downloading said XML file to determine if the said plurality of files are organized in a directory structure that is compatible with said game server, said game client, or both said game server and said game client.

6. The system of claim 1, wherein said Mod service module contains an updater configured for updating a Mod previously present on said user computer upon detecting a change made to that Mod on said CDN and in response to a signal from said user computer that represents a single input.

7. The system of claim 1, wherein said at least one Mod represents a virtual vehicle model.

8. The system of claim 1, wherein said at least one Mod represents a virtual race track model.

9. The system of claim 1, wherein said user computer is selected from among: a desktop computer, a laptop computer, a tablet, a smartphone, a video game console, a portable video game device, a portable digital assistant, an arcade game console, a global positioning system, and an on board vehicle computer.

10. The system of claim 1, wherein said CDN is part of said game server.

11. A method of one-click object model (“Mod”) installation comprising:
hosting a game environment on a host website via one or more game server;
receiving a signal representing a single input from a game client operating on a user computer, wherein said signal represents an indication that a user wishes to prepare the user computer in anticipation of entry into a game;
invoking a Mod service module operatively coupled with said host website to determine if said particular game requires said user to have one or more Mods installed on said user computer;
scanning, using said Mod service module, said user computer to determine whether a required Mod is present on said user computer;
initiating, using said Mod service module, a user download of one or more required Mod from a content delivery network (“CDN”) extracting, using said Mod service module, said at least one required Mod;
analyzing, using said Mod service module, said at least one required Mod; and
automatically installing, using said Mod service module, said at least one required Mod in the appropriate locations on said user computer.

12. The method of claim 11, wherein said CDN is part of said game server.

13. The method of claim 11, wherein said at least one required Mod contains a plurality of files organized in one or more file directories, wherein said plurality of files comprises at least one XML filed describing said at least one Mod, and wherein method further comprises:
downloading, using said Mod service module, said XML file to determine if the said plurality of files are organized in a directory structure that is compatible with said game server, compatible with the game client, or compatible with both said game server and said game client.

14. The method of claim 11, further comprising:
updating, using said Module service module, a Mod that is already present on a user computer upon detecting a change made to that Mod on said CDN and in response to a signal from said user computer that represents a single input.

15. A method comprising:
joining, using a user computer, an interactive game hosted on a website via one or more game server by transmitting a signal representing a single input from a game client operating on said user computer;
invoking, using a user computer, a Mod service module operatively coupled with user computer to determine if said particular game requires said user to have one or more Mods installed on said user computer;
scanning, using said Mod service module, said user computer to determine whether a required Mod is present on said user computer;
initiating, using said Mod service module, a user download of one or more required Mod, in a compressed form, from a content delivery network (“CDN”) extracting, using said Mod service module, said at least one required Mod;
analyzing, using said Mod service module, said at least one required Mod; and
automatically installing, using said Mod service module, said at least one required Mod in the appropriate locations on said user computer.

16. The method of claim 15, wherein said at least one required Mod contains a plurality of files organized in one or more file directories, wherein said plurality of files comprises at least one XML filed describing said at least one Mod, and wherein method further comprises:
downloading, using said Mod service module, said XML file to determine if the said plurality of files are organized in a directory structure that is compatible with said game server.

17. The method of claim 15, further comprising:
updating, using said Module service module, a Mod that is already present on a user computer upon detecting a change made to that Mod on said CDN and in response to a signal from said user computer that represents a single input.

18. A method for automatically installing a 3D object model in an interactive multimedia environment, comprising:
receiving a notification responsive of a single-click on a user computer;
analyzing a file that contains directory and file information describing the 3D object model;
determining if the directory and file information is compatible with the interactive multimedia environment; and
automatically installing the directory and file information in appropriate locations on the user computer;
wherein the interactive multimedia environment operates on the user computer.

19. The method of claim 18, wherein the directory and file information describes a virtual vehicle.

20. The method of claim 18, wherein the directory and file information describes a virtual race track.

21. A system for operating an interactive multimedia environment, comprising:
a game client operating on a user machine;
a game server operating on a host website; and
a database of 3D object models;
wherein an installation program receives a notification responsive of a single-click on a user machine; automatically downloads a compressed file that contains directory and file information describing a 3D object model; decompresses and analyzes the compressed file to determine if the directory and file information is compatible with the interactive multimedia environment; and automatically installs the directory and file information in the appropriate locations on a user machine where the interactive multimedia environment will be operated.

22. The system of claim 21, wherein the directory and file information describes a virtual vehicle.

23. The system of claim 21, wherein the directory and file information describes a virtual race track.

24. The system of claim 21, wherein the 3D object models are provided from a source located on one of: the server and the Internet.
